(19) United States
(12) Patent Application Publication
(10) Pub. No.: US 2009/0254704 A1
(43) Pub. Date: Oct. 8, 2009

(54) MEMORY CARD

(75) Inventors: Yutaka Nakamura, Osaka (JP); Osamu Shibata, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/419,441

(22) Filed: Apr. 7, 2009

(30) Foreign Application Priority Data
Apr. 8, 2008 (JP) 2008-100652

(51) Int. Cl. G06F 12/00

(52) U.S. Cl. 711/115; 711/E12.001

(57) ABSTRACT

The memory card incorporates a memory device for storing information, and has a plurality of contact pads arranged parallel in the width direction for input and output of electric signals relating to the information to be recorded in the memory device or the information being read out from the memory device, provided at the forward end in the length direction. At least one contact pad of the contact pad group in the memory card includes first and second contact pads disposed side by side in the width direction of the memory card, and a third contact pad disposed behind the first and second contact pads in the length direction of the memory card.

### BACKGROUND OF THE INVENTION

1. Field of the Invention

The present invention relates to a memory card incorporating a nonvolatile memory device for storing data.

2. Related Art

Recently, a memory card of small size using a mass storage flash memory composed of a semiconductor material is being established as new removable media (see, for example, non-patent document 1). This is caused by a large capacity and lowering the cost by rapid advancement of the memory device, manufacturing a large-capacity card at lower cost with the development of mounting technology, the compression technology of information, improvement of the communication infrastructure, and the advancement of the security technology, rapid improvement of digital home appliance, or the like. The SD Memory Card is especially the one of the card formats that spread most.

The SD Memory Card is a removable media of the size of 32 mm×24 mm×2.1 nm. The SD Memory Card is inserted in an applicable device (hereinafter a “host device”) and is used (see, for example, JP2004-71175A, JP2003-249290A). The SD Memory Card has nine contact pads, and communicates electrically with the host device by way of a socket provided in the host device, and the data stored in SD Memory Card can be read out, or the data can be written into SD Memory Card from the host device.

FIG. 13 shows a configuration of a portion disposing contact pads in a conventional SD Memory Card. The SD Memory Card 10 is inserted in a conventional socket disposed in a conventional host device, and the memory card is mounted (the memory card is fixed), mounting of the memory card is detected, the position of wrong writing preventive switch is detected, and then the memory card is connected with the socket electrically.

As shown in FIG. 13, a conventional SD Memory Card 10 has contact pads 101 to 109. FIG. 14 shows a structure of a conventional socket corresponding to the conventional SD Memory Card 10 (see “SD Memory Card Style Book,” Impress Editors et al., Impress Japan). A conventional socket 50 has contact pins 501 to 509 to be connected electrically to contact pads 101 to 109 of the SD Memory Card 10.

Usually, the contact pads 101 to 109 of the SD Memory Card 10 are formed on a printed circuit board, and are plated in gold. Usually, the contact pins 501 to 509 of the socket 50 are usually composed of metal parts of gold-plated leaf spring. Hence, when the SD Memory Card 10 is inserted, a stable pressure is applied, and stable electric connection is assured.

In an electrical connection between conventional SD Memory Card 10 and conventional socket 50, the sequence of pins to be connected is determined. That is, when the SD Memory Card 10 is inserted, the contact pad 103 (ground), the contact pad 104 (power source), and the contact pins 503 and 504 of the socket 50 corresponding to these pads are connected in the first place. Then, the contact pads other than the contact pad 101 and the corresponding contact pins of the socket are connected, and finally the contact pad 101 and the corresponding contact pin of the socket are connected. When the SD Memory Card 10 is removed from the socket 50, the connection is disconnected in the reverse sequence. Thus, in the first connection of the power source and the ground, if the SD Memory Card 10 is inserted and removed repeatedly while the power source of the host device is being supplied, the problem of latch-up can be avoided. To realize this inserting and removing sequence, in the conventional SD Memory Card 10, the contact pads 103, 104 are extended ahead of the other contact pins by 0.2 mm or more. Furthermore, in the conventional socket 50, the contact points between the contact pins and the corresponding contact pads are slightly differed in position. The position where contact pin 502,505,506,507,508,509 of the socket corresponding to contact pad 102,105,106,107,108,109 and them comes in contact is located at the center of the contact pads, and the contact points at the contact pads 103, 104 are positioned further behind the center as seen from the leading end of the SD Memory Card, and the contact point of the contact pad 101 is designed to be positioned at a front position from the center as seen from the leading end of the SD Memory Card.

### SUMMARY OF THE INVENTION

The contact pads of the SD Memory Card are electrodes for connecting electrically, having a physical shape, and these constituent elements used as electric gateway are sometimes called “pins” conceptually, and may be called by the term of “pins” when defining the meaning of the signal. FIG. 15 is an explanatory diagram of the configuration and meanings of pins of the SD Memory Card. The SD Memory Card has nine pins (contact pads), and these nine pins include supplying power source or ground potential, transferring data, command and response signals, and transferring the clock for synchronizing these signals.

The SD Memory Card has several operation modes, and depending on the operation modes, some of these nine pins are changed over in their meaning. In the present SD Memory Card, in the operation mode capable of transferring the data most efficiently, four pins are assigned as the pins for transferring the data (input and output). That is, the data in four systems can be transferred at the same time, or in other words, four-bit data can be transferred in one clock cycle.

Recently, in the SD Memory Card, data transfer of higher speed is being demanded in order to record the contents becoming higher in definition, or to record the moving image in real time.

To enhance the data transfer speed in the SD Memory Card, for example, the number of data pins may be increased. In the case of the SD Memory Card, the conventional four data pins can be increased to eight or 16. However, in order to increase the number of data pins, it is required to modify the array and shape of the existing contact pads. For example, a second row and a third row of pads may be prepared behind the existing contact pad row.

In the case of a conventional SD Memory Card, in order to prevent damage of contact pads due to contact with other members, a step of 0.7 mm is provided around the outer circumference (excluding the connecting parts with external socket) of the contact pads of the SD Memory Card, so that the outer circumference of the contact pads may be higher than the contact pads. Therefore, when forming further contact pad rows behind the existing contact pad row, a step different from the existing step must be provided, and the second row of contact pads must be disposed on this different step, and the contact pads cannot be formed easily by utilizing the circuit board on which the integrated circuit is mounted. In future, if data transfer of higher speed is needed, the number of rows must be further increased, and the structure of the corresponding socket is complicated, and the mounting volume of the socket is increased.

In other method enhancing the data transfer speed, it may be considered to increase the transfer rate by increasing the frequency of data transfer clock. But when the transfer clock frequency is increased, the channel may have effects of coupling from other signal line, and the waveform quality is lowered by reflected wave of signal line due to deviation in impedance matching, and it is difficult to increase the transfer clock frequency sufficiently.

Thus, while there is a mounting demand for higher speed in the SD Memory Card, many and various host devices have been already manufactured for use with the SD Memory Card. Since these host devices utilize the SD Memory Card as bridge media, and data and contents have been mutually exchanged, new SD memory cards are required to have compatibility with the existing host devices.

To the contrary, if a conventional SD Memory Card is inserted into a host device (socket) corresponding to a new SD Memory Card capable of transferring at high speed, it is required at least to elicit the operation and the speed performance in the conventional mode. That is, the socket is required to be applicable to both new SD Memory Card and conventional SD Memory Card.

### Gist

The present invention is conceived to solve the problems of the prior art, and it is hence an object thereof to present a memory card having a data memory device in the inside, enabling to transfer data at high speed, while assuring compatibility with the conventional memory card.

To improve the high speed performance of the memory card drastically, it is at least required to narrow the signal amplitude of pins responsible for data transfer, shorten the transition time, and obtain a stable waveform, realize a differential operation, increase the drive frequency substantially to assure a stable operation, and suppress undesired radiation. Accordingly, the memory card must be modified in the shape of contact pads to be suited to differential operation, and increased in the number of necessary pins. In the memory card of this embodiment, a part of the conventional contact pads is divided into three sections, and these problems are evaded, and the high speed performance of the memory card is improved drastically.

The memory card of the present invention incorporates a memory device for storing information, and has a plurality of contact pads arranged parallel in the width direction for input and output of electric signals relating to the information to be recorded in the memory device or the information being read out from the memory device, provided at the forward end in the length direction. At least one contact pad of the contact pads in the memory card includes first and second contact pads disposed side by side in the width direction of the memory card, and a third contact pad disposed behind the first and second contact pads in the length direction of the memory card.

According to the memory card of the present invention, in some of the pins (contact pads) in the conventional memory card, in a region forming such pins, the first and second pins disposed side by side, and the third pin positioned behind these two pins are provided. By such pin configuration, in high speed operation mode, a differential signal is transmitted to the first and second pins, and the third pin is fixed at a predefined electrical potential, and in a normal mode, the first and second pins can be set at high impedance, and the third pin can be used in transfer of predefined signal (command/response, clock). As a result, while maintaining the compatibility with the conventional memory card, data can be transferred at high speed.

### BRIEF DESCRIPTION OF DRAWINGS

FIG. 1 is a perspective view of a memory card in a preferred embodiment of the invention.

FIG. 2 shows a plan view, a back view, a side view, and a front view of the memory card in the preferred embodiment of the invention.

FIG. 3 shows a portion of arrangement of contact pads of the memory card in the preferred embodiment of the invention.

FIG. 4 is a diagram showing names and meanings of pins of the memory card in the preferred embodiment of the invention.

FIG. 5 is a socket configuration diagram corresponding to the memory card in the preferred embodiment of the invention.

FIG. 6 is a configuration diagram of a differential type interface circuit included in the memory card in the preferred embodiment of the invention.

FIG. 7 is the figure which shows a connection state when the memory card of the preferred embodiment of the invention is inserted in the socket of the preferred embodiment of the invention.

FIG. 8 is the figure which shows a connection state when conventional memory card is inserted in the socket of the preferred embodiment of the invention.

FIG. 9 is other socket configuration diagram corresponding to the memory card in the preferred embodiment of the invention.

FIG. 10 is the figure which shows a connection state when the memory card of the preferred embodiment of the invention is inserted in other socket of the preferred embodiment of the invention.

FIG. 11 is the figure which shows a connection state when conventional memory card is inserted in other socket of the preferred embodiment of the invention.

FIG. 12 is the figure which shows a connection state when the memory card of the preferred embodiment of the invention is inserted in conventional socket.

FIG. 13 shows the part where contact pads of conventional memory card are arranged.

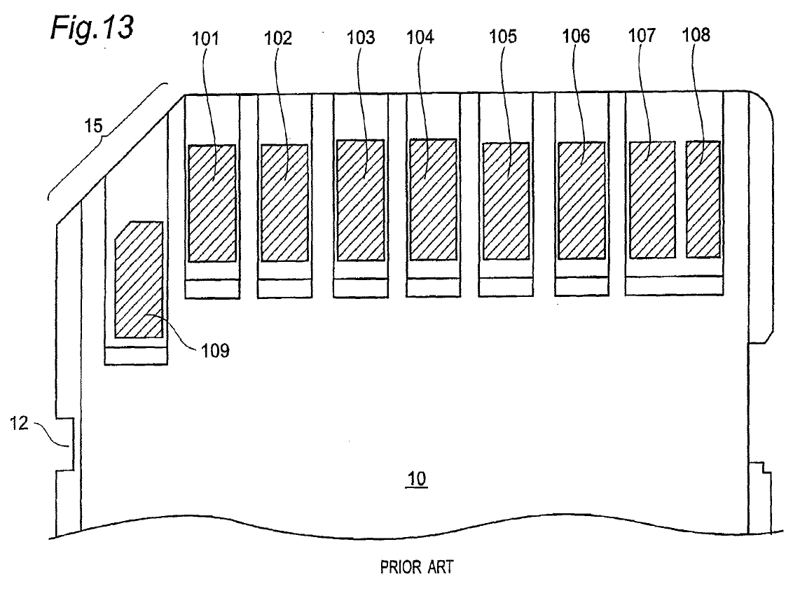

FIG. 14 is a socket configuration diagram corresponding to conventional memory card.

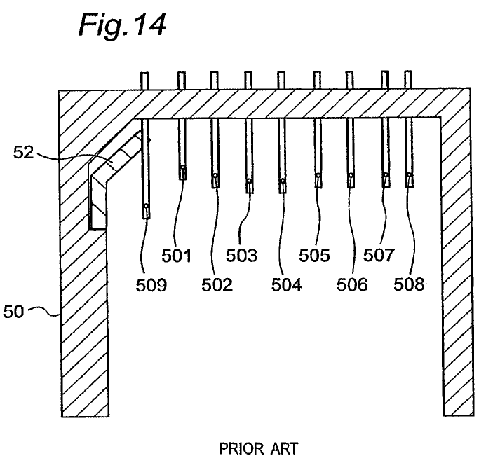

FIG. 15 is a diagram showing names and meanings of pins of conventional memory card.

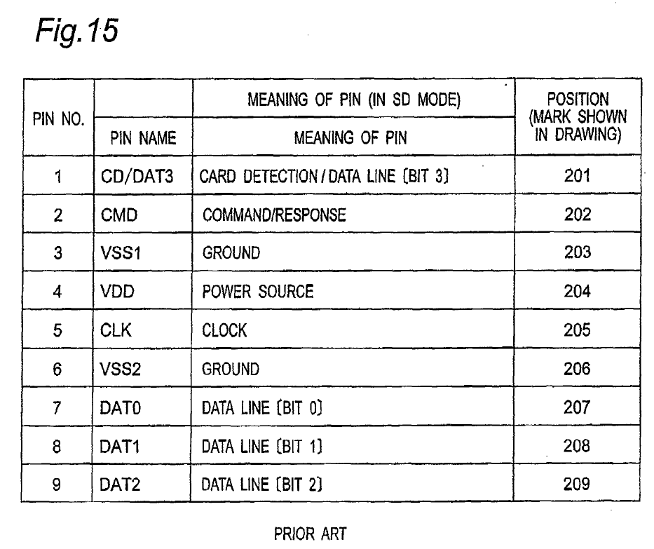

### DETAILED DESCRIPTION OF PREFERRED EMBODIMENTS

Referring now to the accompanying drawings, a preferred embodiment of the invention is described below.

### 1. Configuration of Memory Card

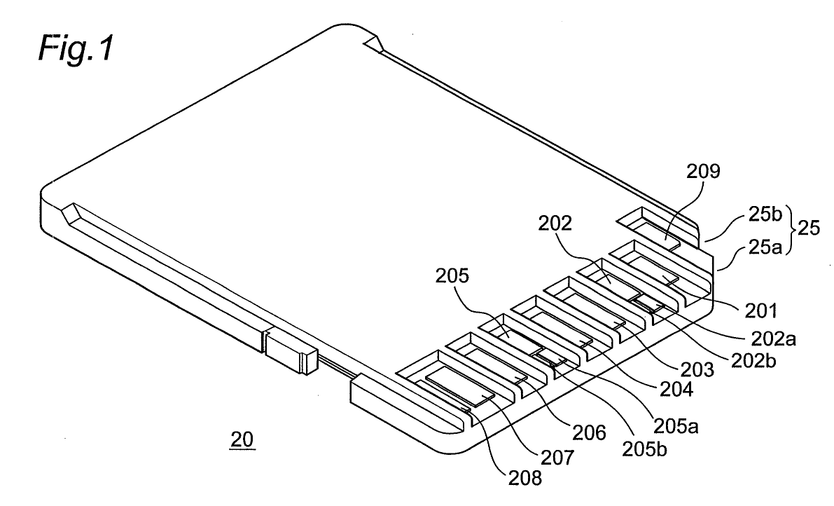

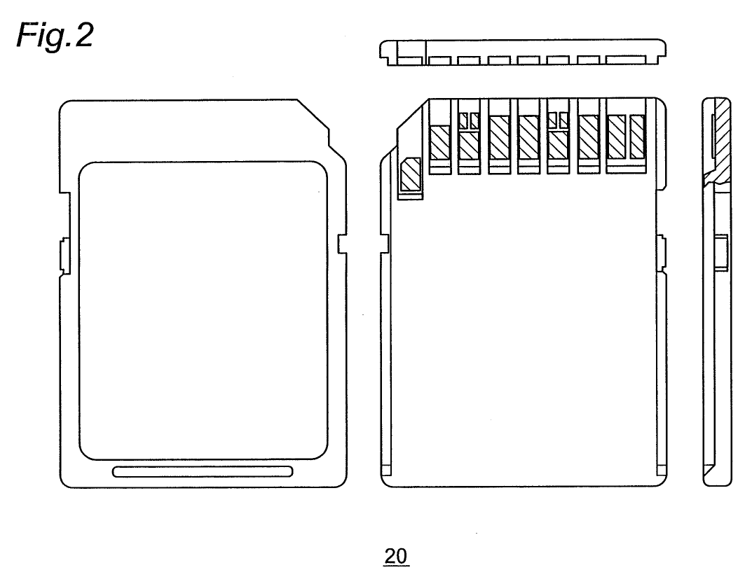

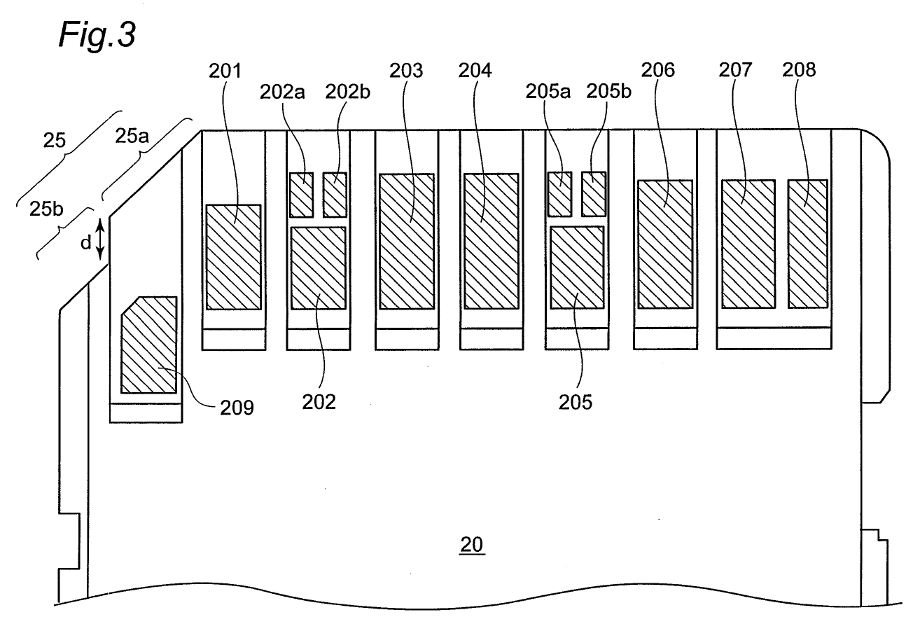

FIG. 1 is a perspective view of SD Memory Card (hereinafter a “memory card”) in a preferred embodiment of the invention. FIG. 2 shows a plan view, a back view, a side view, and a front view of the memory card 20. FIG. 3 shows a portion of arrangement of contact pads of the memory card 20. The memory card 20 includes a nonvolatile memory device such as flash memory for storing information in its inside, and the data written in the memory device or the data being read out from the memory device is exchanged with an external device by way of contact pads.

As shown in FIG. 1 to FIG. 3, the memory card 20 of the preferred embodiment includes contact pads 201 to 209, 202a, 202b, 205a, 205b forward in order to connect electrically. The contact pads 203, 206, 204, 207, 208, 209 of the memory card 20 correspond to the contact pads 103, 106, 104, 107, 108, 109 of the conventional memory card 10. At a position corresponding to the contact pad 102 of the conventional memory card 10, the contact pads 202, 202a, 202b of the memory card 20 of the preferred embodiment are disposed. At a position corresponding to the contact pad 105 of the conventional memory card 10, the contact pads 205, 205a, 205b of the memory card 20 of the preferred embodiment are disposed. The contact pads 209, 201, 202 (202a, 202b), 203, 204, 205 (205a, 205b), 206, 204, and 207 are mutually isolated in shape by insulating ribs.

Furthermore, the memory card 20 has a notch 25 provided at one of forward corners. The notch 25 includes a first notch 25a contacting with the front face of a socket 60, and a second notch 25b provided from the first notch 25a behind by a distance d.

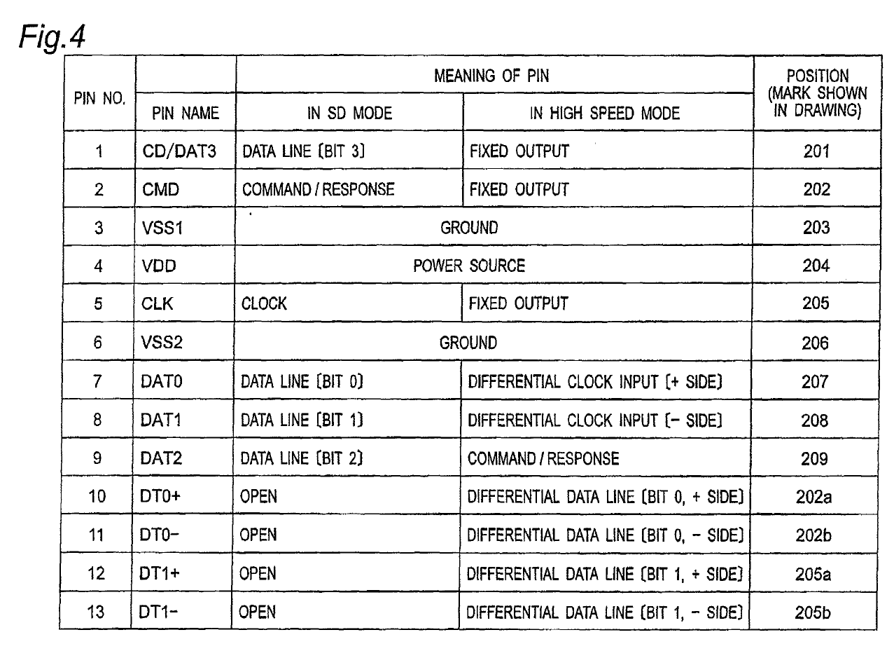

FIG. 4 is a diagram explaining the arrangement and meanings of pins of the memory card 20 in the preferred embodiment. The meanings of some of the pins are different depending on the operation mode (SD mode, high speed mode). The SD mode is a normal operation mode, which is an operation mode defined in the conventional SD card. The high speed mode is a mode capable of transferring data at higher speed than in the SD mode.

Especially, in the high speed mode, the contact pad 202a and the contact pad 202b form a pair, and transmit and receive a differential data signal of one bit. Similarly, the contact pad 205a and the contact pad 205b form a pair, and transmit and receive a differential data signal of one bit. In the SD mode, four-bit data is transmitted and received by using the contact pads 207 to 209, 201, but in the high speed mode, four-bit data is transmitted and received by using the pair of contact pad 202a and contact pad 202b, and the pair of contact pad 205a and contact pad 205b. The high speed mode is smaller in the number of bits transmitted simultaneously than the SD mode, but the frequency of operation clock in the high speed mode is outstandingly higher than in the SD mode, and the data transfer of higher speed is realized.

### 2. Configuration of Socket

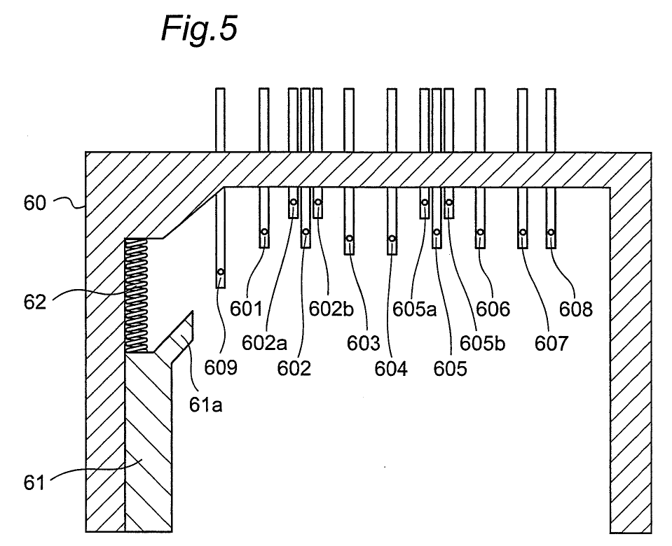

FIG. 5 is a socket 60 configuration diagram corresponding to the memory card 20 in the preferred embodiment (hereinafter called the “socket of the preferred embodiment”). The socket 60 of the preferred embodiment includes a slider 61 for fixing the position of the inserted memory card, and a spring 62 for biasing the slider 61 in the opening direction of the socket when inserting the memory card. The slider 61 has a protrusion 61a for abutting against the shape of the notch 25 specific to the memory card 20 of the preferred embodiment (in particular, a notch portion 25b), to detect the shape of the notch 25 specific to the memory card 20 of the preferred embodiment. The slider 61 guides the memory card 20 into a specified position inside of the socket by the pressing force received by way of this protrusion 61a.

The socket 60 of the preferred embodiment has contact pins 601 to 609, 602a, 602b, 605a, 605b. The contact pins 603, 604, 606, 607, 608, 609 correspond to the contact pins 503, 504, 506, 507, 508, 509 of the conventional socket 50. The contact pins 602a, 602b are pins provided for connecting electrically with the contact pads 202a, 202b of the memory card 20, and are set shorter than the contact pin 602. Similarly, the contact pins 605a, 605b are pins provided for connecting electrically with the contact pads 205a, 205b of the memory card 20, and are set shorter than the contact pin 605. The socket 60 of the preferred embodiment is designed so that not only the memory card 20 of the preferred embodiment, but also the conventional memory card 10 can be inserted. The connection state of the memory cards of the preferred embodiment and conventional art, and the sockets of preferred embodiment and conventional art is described specifically later.

### 3. Operation of Memory Card

Data transfer operation of the memory card 20 of the preferred embodiment is explained. In this preferred embodiment, data transfer pins are provided in two systems. One is a data transfer system using the contact pads 204, 205a, 205b, 206, and 205, and the other is a data transfer system using the contact pads 201, 202a, 202b, 203, and 202.

First is explained the data transfer by using the contact pads 204, 205a, 205b, 206, and 205.

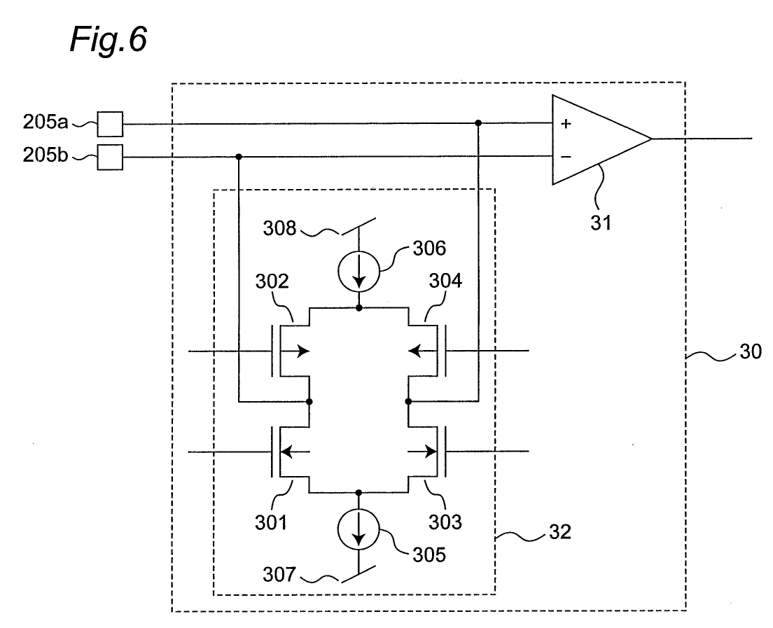

As shown in FIG. 4, the contact pads 205a, 205b are pads for data differential input and output. These pads 205a, 205b are connected to the differential interface circuit inside the memory card 20. FIG. 6 shows an example of configuration of this differential interface circuit.

As shown in FIG. 6, the differential interface circuit 30 includes a differential input circuit 31 operating at the time of input of data into the memory card 20, and a data output circuit 32 operating at the time of output of data from the memory card 20. The differential input circuit 31 detects the difference of signal levels of input data entering by way of the contact pads 205a, 205b, and transmits to a downstream. The differential input circuit 31 is designed so as to be capable of sensing at high speed even if the signal amplitude is as small as 250 mV or less.

The data output circuit 32 is a circuit to output the data read from the nonvolatile memory device (flash memory) in the memory card 20 to the contact pads 205a, 205b.

The data output circuit 32 is composed of n-type transistors 301, 303, p-type transistors 302, 304, and constant current sources 305, 306. The amplitude of output signals to the contact pads 205a, 205b is determined by the voltage of terminals 307, 308. The data output circuit 32 is formed in a mirror current structure, and the transistor can be operated at high speed in non-saturated state, and the output can be driven at a specific slew rate. Accordingly, by suppressing the output amplitude at small amplitude of, for example, 250 mV or less, the data can be transferred at an extremely high speed. At the time of data input, each gate voltage is controlled so that the transistors 301 to 304 will be turned off. When the outputs from the contact pads 205a, 205b are held in high impedance state, similarly, the transistors 301 to 304 are controlled to be turned off.

After turning on the power of the memory card 20, until shifting to a high-speed mode by the command to the memory card 20, this differential interface circuit 30 is controlled in a disabled state, and in this period the contact pad 205 functions same as the contact pad 105 of the conventional memory card 10. After transition to high-speed mode, the contact pad 205 is controlled to output fixed potential at the “L” level or the “H” level.

The contact pads 204, 206 are respectively the pins of the power source and the ground, and a predefined electrical potential is supplied from the host device. Thus, the contact pads 205a, 205b transferring the data at high speed are surrounded by the contact pads 205, 204, 206 at fixed potential, and unnecessary interference is prevented on the circuit board of the memory card 20 and on the configuration of the contact pins of the socket, so that the characteristic impedance of the channel is stabilized.

The contact pads 205a, 205b are connected only to the differential interface circuit 30, and are not connected to the conventional interface circuit contained in the conventional SD Memory Card. Therefore, the differential interface circuit 30 can be designed in a smaller input and output capacitance than the input and output capacitance of the interface circuit of the conventional SD Memory Card. Hence, the capacitance of the contact pads 205a, 205b can be set smaller than the capacitance of the contact pads of the conventional SD Memory Card, so that it is possible to operate at higher speed.

Another data transfer system, that is, the data transfer using the contact pads 201, 202a, 202b, 203, and 202 is basically same as in the data transfer system descried above. To the contact pads 202a, 202b, the circuit similar to interface circuit 30 is connected.

The contact pad 201 is controlled to issue an output of fixed potential of “L” level or “H” level after transition to high-speed mode by the command. As a result, the contact pads 202a, 202b transferring the data at high speed are enclosed by the contact pads 201, 203 at fixed potential, and unnecessary interference is prevented on the circuit board of the memory card 20 and on the configuration of the contact pins of the socket, so that the characteristic impedance of the channel is stabilized. The contact pad 201 functions same as the contact pad 101 of the conventional SD Memory Card from the start of the supply of power into the card until transition to high speed mode by the command.

Because of the above configuration, in each system of data transfer, data transfer is enabled at a rate of 2.5 GHz. Even if the data is modulated in order to average the transfer data, that is, to improve the “L” and “H” balance of the data, data transfer performance of 250 MB/s can be obtained, and by the pins of two data transfer systems, data transfer performance of maximum of 500 MB/s can be obtained.

### (Consideration of Hot-Swap in Memory Card)

When the memory card 20 of the preferred embodiment is inserted in the socket 60 of the preferred embodiment or the conventional socket 50 while a voltage is applied to power source pins or input pins of the socket 60 or 50, same as in the conventional SD Memory Card, the contact pad 203 (ground) and the contact pad 204 (power source) are first connected to the contact pins of the socket. At this time, in the memory card 20 of the preferred embodiment, the extended contact pads 202a, 202b, 205a, 205b are all designed to be in high impedance state. Hence, there is no risk of damage given to the host device side or the memory card side.

When the memory card 20 is inserted into the socket 60 of the preferred embodiment, power is supplied, and the differential interface circuit 30 is operating, if the memory card 20 is pulled out, short-circuiting may occur between the contact pads 202a, 202b, and the contact pin 602. However, the data output circuit 32 connected to the contact pads 202a, 202b is limited in its output current by constant current sources 305, 306. Accordingly, if short-circuiting should occur between the contact pads 202a, 202b, and the contact pin 602, flow of excessive current can be prevented, and damage of the host device and the memory card can be prevented. Similarly, while the host device corresponding to the memory card 20 of the preferred embodiment is sending out data and the data is entered in the memory card 20, the data output circuit in the host device is limited in the output current by the constant current source same as the data output circuit 32 in the memory card 20, and damage can be prevented. That is, if the memory card 20 is removed during operation of the memory card 20 and/or the host device, destructive damage is not given to the memory card 20 and the host device.

### 4. Connection State of Memory Card and Socket

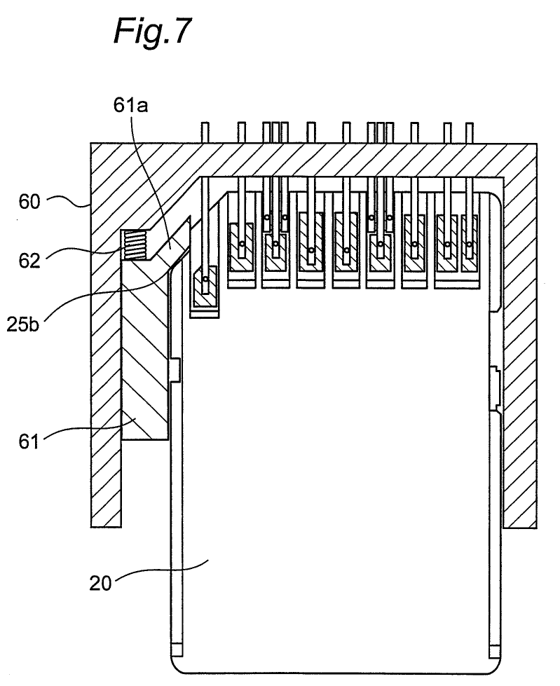

FIG. 7 is a connection state diagram when the memory card 20 of the preferred embodiment is inserted in the socket 60 of the preferred embodiment. The memory card 20 is inserted into a position where a spring 62 is contracted maximally while a second notch 25b is abutting against a protrusion 61a of the slider 61. Thus, as being inserted into socket 60 of the preferred embodiment, each contact pin of the socket 60 is electrically connected to each corresponding contact pad of the memory card 20. As a result, operation of high speed mode is enabled in the memory card 20.

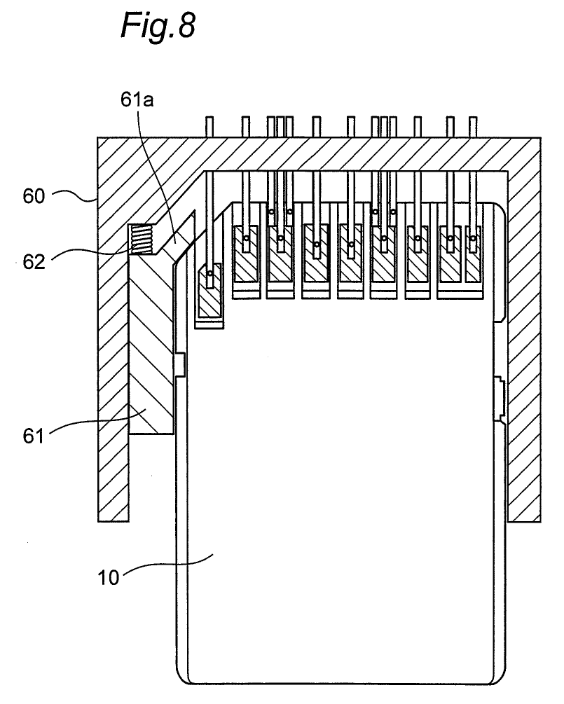

FIG. 8 is a connection state diagram when the conventional memory card 10 is inserted in the socket 60 of the preferred embodiment. The conventional memory card 10 is inserted into a position where the spring 62 is contracted maximally while the notch 15 is abutting against the protrusion 61a of the slider 61. Herein, as compared with the case shown in FIG. 7, it may be understood that the memory card 20 of the preferred embodiment is inserted into the socket 60 deeper than the conventional memory card 10 shown in FIG. 8, by the portion of step (d) by the notch 25b. That is, since the conventional memory card 10 is inserted more shallowly in the socket 60 of the preferred embodiment, the contact pins 602a, 602b, 605a, 605b of the socket 60 are not connected to any one of the contact pads of the conventional memory card 10.

Thus, the socket 60 of the preferred embodiment detects a shape difference of the notch of the memory card by the protrusion 61a of the slider 61, and the memory card is guided into a predefined fixed position depending on its shape. That is, by the notch shape of the memory card of the preferred embodiment different from that of the conventional memory card, the memory card 20 of the present embodiment can be distinguished from the conventional memory card 10, so that the connection state between the memory card and the contact pins of the socket can be changed.

Suppose if there is no such function, if the conventional memory card 10 is inserted into the socket 60 of the preferred embodiment, the contact pads 102, 105 of the memory card 10 are connected respectively to the three contact pins 602a, 602, 602b, and 605a, 605, 605b of the sockets. These three contact pins 602a, 602, 602b, and 605a, 605, 605b are respectively connected to the wiring of the host device and the foregoing terminals of the LSI, and high speed operation is disabled. That is, extra pins are connected, and a larger load is connected to the memory card than in the case of operation in combination of the conventional SD Memory Card and the conventional socket, and in a conventional manner high speed performance cannot be maintained. This problem can be avoided by the protrusion 61a of the slider 61 of the socket 60 in accordance with the preferred embodiment.

### (Other Configuration Example of Socket)

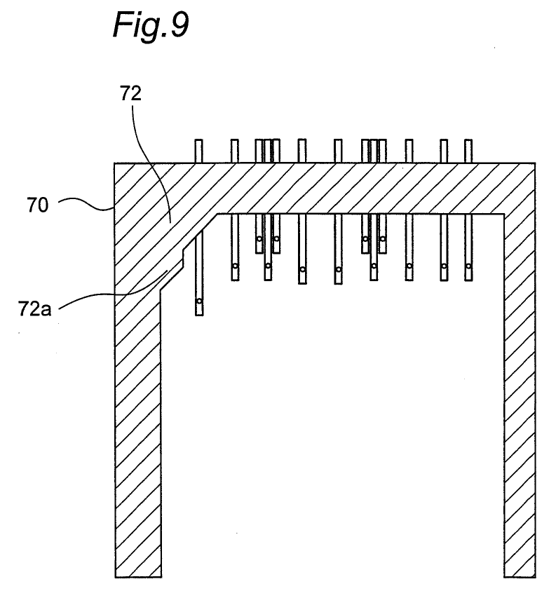

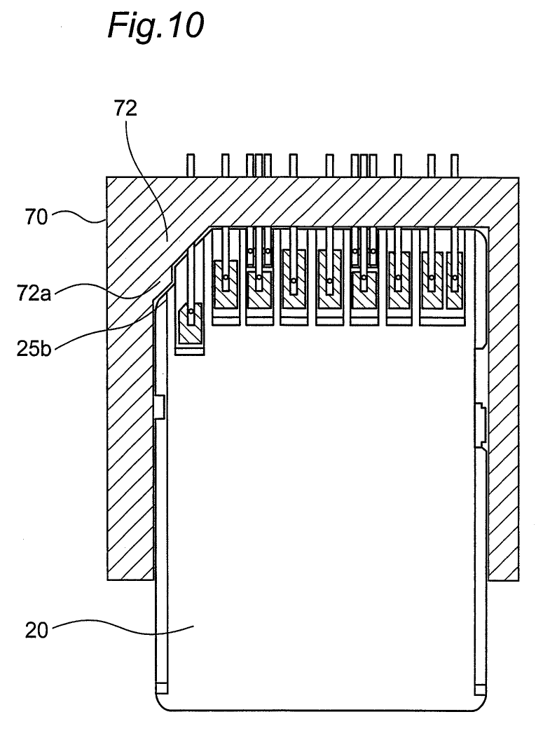

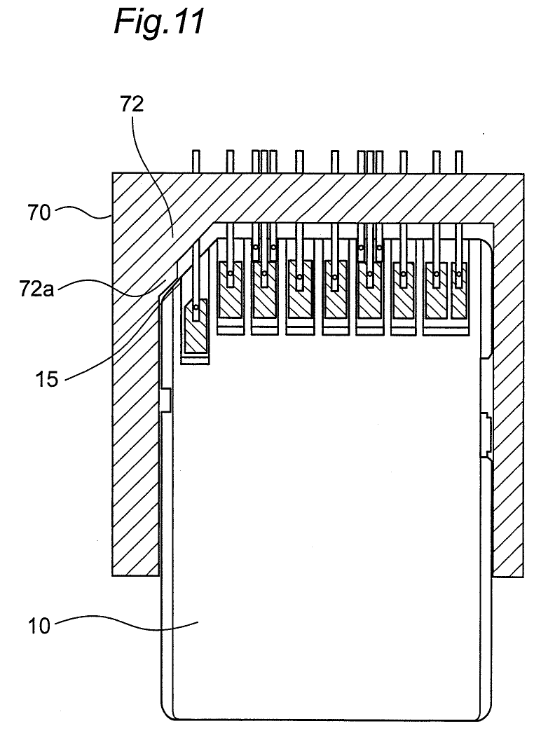

FIG. 9 shows other configuration example of the socket corresponding to the memory card of the present embodiment. As shown in the diagram, a socket 70 is formed in a shape corresponding to the shape of the notch 25 of the memory card 20 of the preferred embodiment, and has a stopping part 72 having a shape abutting against both notches 25a, 25b when the memory card 20 is inserted into the deepest position. This stopping part 72 has same functions as the protrusion 61a of the slider 61. That is, when the memory card 20 is set into the socket 70, the memory card 20 is inserted deeply into the socket 70 until the second notch 25b of the memory card 20 touches a second portion 72a of the stopping part 72 of the socket 70 as shown in FIG. 10. On the other hand, when the conventional memory card 10 is inserted into the socket 70, as shown in FIG. 11, at the place where the notch 15 of the memory card 10 comes in contact with a step 72a of the stopping part 72 of the socket 70, the memory card 20 is fixed. Thus, by forming such protruding step 72a, the shape of the notch of the memory card can be detected, and the memory card of the preferred embodiment can be inserted into the socket more deeply than the conventional memory card. As a result, between the memory card of the preferred embodiment and the conventional memory card, the electrical connection state between the memory card and the pin of socket can be varied.

Thus, the socket of the preferred embodiment corresponding to the memory card of the preferred embodiment can vary the inserting position (inserting depth) of the memory card on the basis of the shape of the memory card. That is, on the basis of the shape of at least one part of the memory card of the preferred embodiment, the inserting position of the memory card into the socket can be deepened or shallowed, so that the electrical connection state between the socket and the memory card pins can be changed over.

### (Connection State of Memory Card of Preferred Embodiment and Conventional Socket)

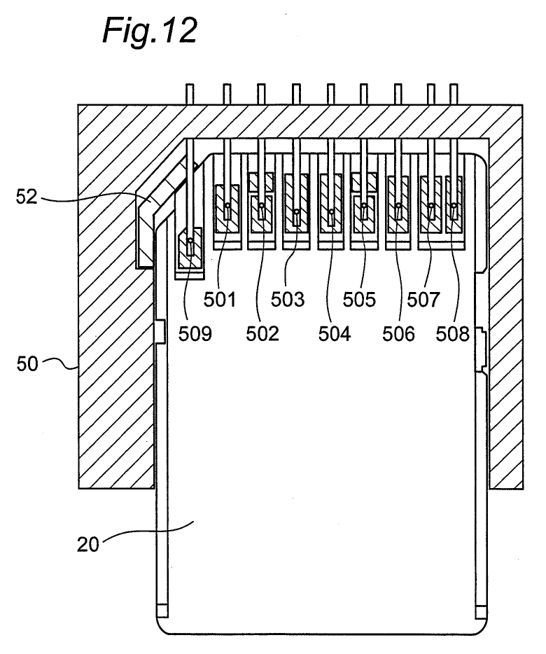

FIG. 12 is a connection state diagram when the memory card 20 of the preferred embodiment is inserted into the conventional socket 50. At the fixed position of the memory card 20, in the memory card 20 of the preferred embodiment, the pins having the same function as those of conventional memory card 10 are all connected to the contact pins 501 to 509 of the conventional socket corresponding to the conventional memory card 10. Accordingly, in the host device corresponding to the conventional memory card, the memory card of the preferred embodiment can be used same as the conventional memory card.

### 5. Conclusion

According to the preferred embodiment, for a part of pins (contact pads) of the conventional memory card, in the region in which the part of pins are formed, first and second pins are disposed side by side, together with a third pin disposed behind the two pins. According to the configuration of such pins, in the high speed operation mode, a differential signal is transferred to the first and second pins, and the third pin is fixed at a predefined electrical potential, and in the normal mode, the first and second pins are set at high impedance, and the third pin can be used for transfer of predefined signal (command/response, clock). As a result, data transfer of high speed is realized.

Specifically, according to a conventional SD Memory Card, the frequency of data transfer clock is about 100 MHz at maximum practically, and the data transfer rate is about 50 MB/s at maximum. On the other hand, according to the method of the preferred embodiment, a data transfer clock of about 2.5 GHz is possible. Also, even if the data is modulated to improve the “L” and “H” balance of the data, a data transfer rate of about 250 MB/s is possible in serial transfer, and a high speed effect of about five times is expected. Moreover, the data can be divided into two bits, and can be transmitted from two pairs of contact pad groups at the same time, so that a high speed effect of about ten times is expected. Still more, since the frequency of the data transfer clock can be raised, much higher effects are expected.

In an SD Memory Card corresponding to high speed, the compatibility with the conventional host device can be maintained by applying the present invention that has the operation mode capable of being controlled by a conventional host device and being connected with the contact pins of the socket of the conventional host device.

Further, the notch shape provided at the end of a beginning side in the inserting direction is formed to have two steps in the notch portion, and the one of the two steps located on the end side is shifted backward by predetermined amount. Therefore in the socket corresponding to the memory card of the preferred embodiment, even if a conventional memory card is inserted, the load capacitance is not increased unexpectedly, and the speed performance of the conventional memory card can be maintained.

The socket of the preferred embodiment detects the shape of the notch in the memory card, and varies the depth of the inserting position of the memory card depending on the shape, thereby varying the electrical connection state between the contact pins of the socket and the contact pads of the memory card. Since the memory card of the preferred embodiment has a notch of a different shape from the conventional memory card, the socket of the preferred embodiment is applicable to both the memory card of the preferred embodiment and the conventional memory card as well.

In the explanation of the preferred embodiment, a substantial improvement of data transfer performance in the SD Memory Card is described, but the concept of the invention can be applied similarly to the SDIO Card, and the data transfer performance can be enhanced while maintaining the compatibility.

In the foregoing explanation, the SD Memory Card is explained as an example of a memory card, but the memory card is not particularly limited. The memory card may be of the other type as long as it includes an integrated circuit and contact pads formed on the same plane. For example, Memory Stick, Smart Media, xD Picture Card and others may be used.

Generally, in the manufacturing process, the pins (contact pads) of the SD Memory Card are connected to plating leader line for plating and electroplated coating. The plating leader line for plating are cut off to a certain extent when mounting the pins (contact pads), but certain chips are not cut off. If the length of the remaining chips of the plating. leader line is longer, the high frequency characteristic is worsened in operation.

However, according to the preferred embodiment, since the first and second pins (contact pads) are placed side by side ahead of the third pin (contact pad), the length of the plating leader line for plating connected the pins can be shortened. As a result, the high frequency characteristic can be substantially improved, and it is applicable to high speed trend of signal processing.

If the first and second pins are placed side by side behind the third pin, the plating leader line for plating connected to the first and second pins must be extended over the front third pin, or must be wired in the disposition direction of the first and second pins, and the length of the plating leader line for plating cannot be shortened, and the high frequency characteristic is worsened. It is hence essential to dispose the first and second pins (contact pads) ahead of the third pin (contact pad).

### INDUSTRIAL APPLICABILITY

The memory card of the present invention is capable of enhancing the speed of data transfer while maintaining the compatibility with the prior device, and is very effective in the application demanding data transfer of high speed.

The foregoing explanation is limited to a specific embodiment of the present invention, but will be clearly many variations, alternatives or other use in applications by those skilled in the art. It is therefore understood that the preferred embodiment is not limited to the disclosed embodiment alone, but may be limited by the scope of the attached claims herein. The present application is related to the former Japanese patent application, Patent Application No. 2008-100652 (filed Apr. 8, 2008), the entire contents of which are incorporated herein by reference.

What is claimed is:

1. A memory card incorporating a memory device for storing information, and having a plurality of contact pads arranged parallel in the width direction for input and output of electric signals relating to the information to be recorded in the memory device or the information being read out from the memory device, provided at the forward end of the memory card in the length direction,
wherein at least one contact pad of the contact pads in the memory card includes first and second contact pads disposed side by side in the width direction of the memory card, and a third contact pad disposed behind the first and second contact pads in the length direction of the memory card.

2. The memory card according to claim 1, wherein the at least one of the contact pads and its adjacent contact pad are isolated by a rib.

3. The memory card according to claim 1, wherein a notch shape is provided at the forward end in length direction of the memory card, and the notch shape is in a shape having a step backward behind the length direction by a predefined length at the lateral side of the memory card.

4. The memory card according to claim 1, wherein the memory card has a first operation mode, and a second operation mode providing faster operation than the first operation mode, and the third contact pad transmits a predefined signal during operation in the first operation mode, and is fixed at a predefined electrical potential during operation in the second operation mode.

5. The memory card according to claim 1, wherein a contact pad adjacent to the at least one of the contact pads can be connected to the ground or a power source or a predefined fixed voltage.

6. The memory card according to claim 1, wherein the capacitance connected to each of the first and second contact pads are smaller than the capacitance connected to the third contact pad.

7. The memory card according to claim 1, further comprising a differential interface circuit including a transistor, being connected to the first and second contact pads, wherein the differential interface circuit provides high impedance when the transistor is turned off.

8. The memory card according to claim 7, wherein the third contact pad can be connected to a predefined fixed electrical potential when high speed differential data is transferred by way of the first and second contact pads.

9. The memory card according to claim 7, wherein the differential interface circuit has means for limiting the output current.
